(19) United States
(12) Patent Application Publication
(10) Pub. No.: US 2025/0313423 A1
(43) Pub. Date: Oct. 9, 2025

(54) METHOD AND SYSTEM FOR MONITORING THE PERFORMANCE OF A WINDING SPOOL IN THE REEL SECTION OF A PAPER MACHINE

(71) Applicant: Valmet AB, Sundsvall (SE)

(72) Inventors: Bartlomiej MADURA, Klucze (PL); Johanna PIHL, Karlstad (SE); Christian BOTHÉN, Karlstad (SE)

(21) Appl. No.: 18/869,535

(22) PCT Filed: Jun. 8, 2023
(86) PCT No.: PCT/EP2023/065323

§ 371 Date: Nov. 26, 2024

(30) Foreign Application Priority Data
Jun. 27, 2022 (SE) 2250794-1

(51) Int. Cl. B65H 26/02; B65H 18/26; B65H 19/30

(52) U.S. Cl. CPC B65H 26/02; B65H 18/26; B65H 19/30; B65H 2301/542; B65H 2301/544; B65H 2511/512; B65H 2515/50

(57) ABSTRACT

The present invention relates to a system (200) and computer implemented method for monitoring the performance of at least one winding spool (120) in the reel section (100) of a paper machine, by detecting a unique identification code, ID, associated with the winding spool (120) from a marker (130) on the winding spool (120); identifying the winding spool (120) based on the unique identification code, ID; determining at least one winding spool performance parameter for the identified winding spool (120) based on measurements from at least one sensor (160); and determining if there is a failure of the performance of the identified winding spool (120) based on if the determined at least one winding spool performance parameter fulfils a requirement indicative of failure of the performance of the winding spool (120). The invention further includes a computer program comprising software for executing the method, a non-volatile data carrier, and a paper machine comprising the system.

### TECHNICAL FIELD

The present invention relates to a method and system for monitoring the performance of at least one winding spool in the winding system in a section of a paper machine, such as a reel section. Monitoring of the performance of at least one winding spool in likeness with the invention presented herein may also be applied to, continue in, a subsequent machine such as a winder, a rewinder or a converter, if the winding spool is transferred to such a machine after the reel section.

In the term paper machine we include machines for producing paper, board, tissue, non-woven products, textiles or any other suitable web material.

### BACKGROUND

A paper machine (or paper-making machine) is an industrial machine which is used in the pulp and paper industry to continuously produce paper, paper board, tissue, non-woven products, textiles etc. in large quantities at high speed. Paper machines have several distinct operational sections, which may typically include a forming section, a press section, a drying section, a size press section, a sheet transfer section, and a reel section. They may also include for example a coating section to modify the surface characteristics with coatings.

The present disclosure relates to the reel section, where paper product exiting the sheet transfer section of the machine is wound onto individual rolls (parent rolls, master rolls) for further processing. The paper product is in the reel section wound onto winding spools, for example metal spools, reel spools, core shafts with cores thread thereon, etc. using either a large cylinder, commonly referred to as a reel drum, or a reel belt. Constant nip pressure is maintained between the reel drum or reel belt and the winding spool, allowing the resulting friction to spin the winding spool. Paper product runs over the top of the reel drum, or along the reel belt, and is wound onto the core of a winding spool to create a parent roll, or master roll.

Removal, adjustments or maintenance of faulty or damaged winding spools is important to avoid that the winding spools cause severe issues in the process, leading to a decrease in yield due to suboptimal winding, time for an operator that needs to remove the winding spool and perform maintenance and/or time consuming and expensive downtime due to the need to halt the process to identify and correct the problem.

The main method today of ensuring that removal, adjustments, or maintenance of faulty or damaged winding spools is done in time is to, when a problem in production is noticed by an operator, stops the operation of the reel section or removes the windning spool from the reel section during operation to manually assess the components of the reel section, including the winding spools, by ocular inspection. If the operator concludes that there is an issue with an inspected winding spool, the operator can then initiate a suitable maintenance action. Of course, such expensive halting of the process is undesirable. Furthermore, there is a great risk of errors being made and maintenance or replacement needs being missed by the operator in their manual assessment of the winding spools. There is also always a risk of injury involved for the operator manually interacting with the paper machine.

To aid the operator in their ocular inspection effort, the winding spools may be marked, for example using various symbols and colors on the brake drum of the winding spools, to be distinguishable from each other. However, to enable each of the markings, each of the identifications as well as each of the maintenance actions the production must be halted, leading again to great costs and time losses.

There is a need for an improved maintenance of winding spools in the reel section of a paper machine, achieving reduced downtime, reduced need of manual work and therefore increased safety of the operator, improved maintenance accuracy and prolonged life span of the reel winding spools and hence improved performance of the reel section.

SUMMARY

The object of the present invention is to eliminate or at least to minimize the problems discussed above. This is achieved by a system and method for monitoring the performance of at least one winding spool 120 in the reel section (100) of a paper machine, a paper machine comprising the system, a computer program for performing the method, and a non-volatile data carrier containing the computer program, according to the appended independent claims.

As mentioned herein, there is a great risk of errors being made and maintenance or replacement needs being missed by an operator performing a manual assessment of winding spools in a reel section. One source of error is that the operator makes the assessment at one point in time, not taking into account changes of the winding spool over time. Thereby, the monitoring of the winding spools in the reel section is greatly improved. Specifically, as both the need for manual labour and the downtime of the paper machine is reduced, embodiments herein lead to reduced time and cost for maintenance of the winding spools, the reel section and by extension the entire paper machine and paper mill. Advantageously, the reduction or even removal of manual monitoring and replacing of this with automated monitoring using embodiments described herein further improves the accuracy of the maintenance of the winding spools in the reel section, and thereby further improves the entire production process of the paper machine and the paper mill. The resulting yield of the production process will be higher, due to less downtime due to both reduction of manual handling and more accurate maintenance, which contributes to maximizing utilization of the winding spools and also increasing the lifespan of other machine components that may be subjected to wear due to faulty winding spools.

In a first aspect of the invention, there is provided a system for monitoring the performance of at least one winding spool in the reel section of a paper machine. The system comprises: at least one winding spool, each having a respective marker comprising information on a unique identification code, ID, associated with the winding spool; at least one detector configured to detect the respective marker on each winding spool, wherein the at least one detector is operatively connected to the reel section and is positioned along a winding cycle of the at least one winding spool; at least one sensor configured to determine a parameter indicative of the performance of the winding spool; a memory; and processing circuitry communicatively connected to the at least one detector, the at least one sensor and the memory. Each of the at least one detector is configured to, for each of the at least one winding spool, detect a unique identification code, ID, associated with the winding spool from the respective marker on the winding spool. The processing circuitry is configured to, for each of the at least one winding spool: identify the winding spool based on the unique identification code, ID; determine at least one winding spool performance parameter for the identified winding spool based on measurements from one or more of the at least one sensor; and determining if there is a failure of the performance of the identified winding spool based on if the determined at least one winding spool performance parameter fulfils a requirement indicative of failure of the performance of the winding spool.

In a second aspect of the invention, there is provided a computer implemented method for monitoring the performance of at least one winding spool in the reel section of a paper machine, the reel section being operatively connected to at least one detector configured to detect a respective marker on each winding spool, the at least one detector being positioned along a winding cycle of the at least one winding spool. The method comprises, for each winding spool: detecting a unique identification code, ID, associated with the winding spool from a marker on the winding spool, using at least one of the at least one detector; identifying the winding spool based on the unique identification code, ID, using processing circuitry communicatively connected to the detector; determining, using the processing circuitry, at least one winding spool performance parameter for the identified winding spool based on measurements from at least one sensor; and determining, using the processing circuitry, if there is a failure of the performance of the identified winding spool based on if the determined at least one winding spool performance parameter fulfils a requirement indicative of failure of the performance of the winding spool.

The invention further includes a paper machine comprising the monitoring system according to any of the embodiments described herein.

The invention is further realized by a computer program loadable into a non-volatile data carrier communicatively connected to a processor, the computer program comprising software for executing the method according to any embodiment presented herein when the computer program is run on the processor, and by a non-volatile data carrier containing the computer program.

Thus, in all aspects of the invention, there is provided an automated solution for tracking winding spools for the purpose of assessing the properties of each identified winding spool itself, without requiring any additional work from the operators, and further using the knowledge gained to draw conclusions on faulty spools, maintenance actions required, etc. Tracking of said indicators improves the overall performance of the machine by identifying faulty winding spools and pinpointing underlying causes, leading to better maintenance practices, as further explained herein.

Additional embodiments of the invention are described in the appended dependent claims and in the detailed description in connection with the drawings. Advantages described in connection with an embodiment of one aspect of the invention, in the summary, the detailed description or the claims, also applies to corresponding embodiments of any other aspect of the invention described herein.

Many additional benefits and advantages of the present invention will be readily understood by the skilled person in view of the appended claims and drawings and the detailed description below.

### DRAWINGS

The invention will now be described in more detail with reference to the appended drawings, wherein:

FIG. 1 schematically discloses a reel section of a paper machine and monitoring of the performance of at least one winding spool in said reel section, according to one or more embodiments of the invention;

FIG. 2 schematically discloses a system for monitoring the performance of a winding spool in the reel section of a paper machine, according to one or more embodiments of the invention;

FIG. 3 is a flow diagram illustrating a method for monitoring the performance of at least one winding spool in the reel section of a paper machine, according to one or more embodiments of the invention;

FIG. 4 is a flow diagram illustrating optional sub-steps of step 310 in FIG. 3;

FIG. 5 is a process flow illustrating how the at least one winding spool moves through the winding cycle in the reel section and how information is sent between system components;

FIG. 6 discloses schematically the winding cycle of FIG. 5;

FIG. 7a schematically illustrates the separate parts of a winding spool, a core and a roll of paper product; and

FIG. 7b schematically illustrates an assembly of a winding spool, a core and a roll of paper product.

All the figures are schematic, not necessarily to scale, and generally only show parts which are necessary in order to elucidate the respective embodiments, whereas other parts may be omitted or merely suggested. Any reference number appearing in multiple drawings refers to the same object or feature throughout the drawings, unless otherwise indicated.

### DETAILED DESCRIPTION

### Introduction

The invention is an automated solution for tracking winding spools (which may also be referred to as reel spools, core shafts, winding shafts, spindles etc.) in the reel section of a paper machine for the purpose of assessing at least one property of each identified winding spool, and further using the knowledge gained to draw conclusions based on the at least one property to detect faulty winding spools, determine if a maintenance action is required, etc. Monitoring of the performance of at least one winding spool in likeness with the invention presented herein may also be applied to, or continue in, one or more subsequent machine such as a winder, a rewinder and/or a converter, if the winding spool is transferred to any such a machine after the reel section. Also in these subsequent machines each individual winding spool can be identified using embodiments presented herein, information stored regarding performance parameters of the winding spool may be used to draw conclusions on the cause of deviations in the processing in the subsequent machines, additional performance parameters may be determined by the processing circuitry in the subsequent machines using determination methods similar to embodiments described herein in relation to the reel section, and an alarm or prompting to operator may be generated and/or automatic maintenance or removal of the winding spool may be initiated if the winding spool is determined to be faulty in any manner described herein.

Embodiments described herein is enable automatic tracking of key performance indicators without requiring any additional work from the operators. Tracking of said indicators can improve overall performance of the machine by identifying faulty winding spools and pinpointing underlying causes, leading to better maintenance practices, as explained herein. One issue that the inventors have identified with prior solutions for identification, both automatic and using visual markings, is that they are mainly connected to asset monitoring and management. One example of such related technology is found in US20210261374 A1, which discloses a method for predicting the presence of product defects during an intermediate processing step of a thin product wound in a roll. According to US20210261374 A1, a unique identification code is used for each roll of thin paper product and process and/or product parameters detected in the production steps of said thin product wound in said roll upstream of said intermediate processing step, associated with said unique identification code, is stored. The stored product parameters are used for generating predictive diagnosis information of thin product defects based on the result of said comparison. US20210261374 A1 does not disclose anything relating to identifying the individual winding spools or assessing properties of the individual winding spools to improve paper production.

In prior solution, there is no automatic identification of individual winding spools in the winding cycle of the reel section. There is further no logging or monitoring of key performance indicators for the individual winding spools. Therefore, in order to identify a faulty winding spool or detect that there is need for maintenance of an individual winding spool an operator must make a manual assessment. Other options are to perform maintenance or replacement of winding spools at predetermined times or intervals. Of course, this means that some winding spools will be subjected to maintenance or replacement although they are still functioning properly, which leads to a waste of time, material, and money, while other winding spools risk remaining in the winding cycle even though they are faulty, which leads to reduced yield and may even lead to damaging the reel section or other parts of the paper machine. Each manual inspection of course also leads to additional downtime.

As another specific example, since prior solutions do identify individual winding spools during operation, they do not and cannot use information about the exact weight of the individual winding spool during winding. Instead, the average weight is used both during nip control in winding, and during paper weighing. This leads to suboptimal winding performance and potential losses due to underestimation of paper weight.

As the inventors have realized, there are several controls and measurements performed in the winding process that are connected to the properties of the winding spool and that are improved if the properties of the individual winding spools are monitored using embodiments described herein.

For instance, to optimize nip load control during winding, the weight of the winding spool may be used in the calculation. Additionally, or alternatively, the weight may also used when calculating the weight of the paper on the parent roll. Thus, the actual weight of the individual winding spool is used to optimize winding performance and to ensure that the paper weight is calculated accurately. The proposed system therefore allows, in some embodiments, for use of the actual, predetermined, weight of the winding spool in nip load control and paper weight calculations. This leads to increased winding performance and reduction of losses due to underestimation of the paper weight.

### Definitions

When it is stated herein that two components are operatively connected to each other, this is to be understood as the components being connected to each other in such a way that a signal, a movement or a force can be transmitted from one to the other. For instance, that a vibration sensor is operatively connected to a component of the reel section is to be understood as the component of the reel section being able to bring the vibration sensor to vibrate and thus register vibrations of the component.

The terms “upstream” and “downstream” are used herein in relation to a movement direction of a fabric or a paper web in a paper machine. Thus, a location that is upstream of another is a location that any given point on the fabric or paper web passes before arriving at the other. The terms “before” and “after” are used to denote that any given point on the paper web passes a location “before” another at an earlier point in time than a location that is “after” the other.

A reel section, or simply reel, is herein defined as a section of a paper machine that reels (winds, wraps) a paper product onto winding spools to create parent rolls which are used later in the paper product manufacturing process. A reel is typically used in high speed conditions, for instance where the paper product comes from a paper machine or coater.

Reeling is herein defined as winding a sheet of paper product onto winding spools.

A winding spool is a metal roll onto which the web is wound during reeling operations. Herein, a winding spool may be referred to as a reel spool, winding shaft, core shaft, spindle, etc.

A parent roll, or master roll, is herein defined as the product of a reel, in the form of a roll of paper product tightly wrapped around a cylindrical core on a winding spool. A parent roll goes through additional processes or rewinding at a later stage of production.

A core is the cylindrical core on which the paper product is wound to produce the parent roll. The core is after reeling, or winding, removed from the winding spool together with the paper product finished of the parent roll wound thereon.

A core shaft is an inflatable winding spool. It is inflated/deflated, in the inflate/deflate station, to hold or release the core of a paper product roll.

The terms “web” and “sheet” may be used interchangeably to refer to the continuous sheet of paper product coming from the paper machine, or from the parent roll.

Turn-up is herein defined as the process of switching the web from a nearly completed building parent roll to an empty winding spool, or the first time the web is attached to a core of a winding shaft at start-up. An unsuccessful turn-up is understood as when the web breaks during the turn-up process.

### System Architecture

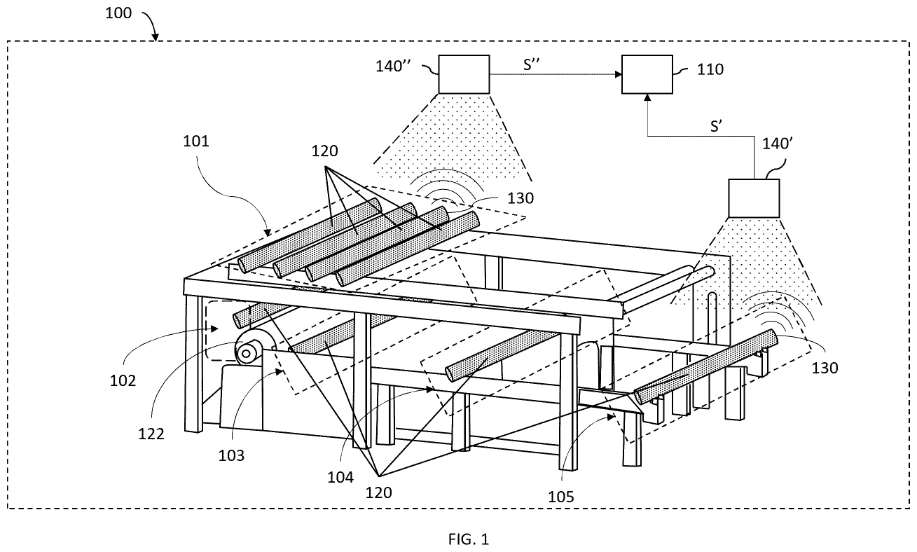

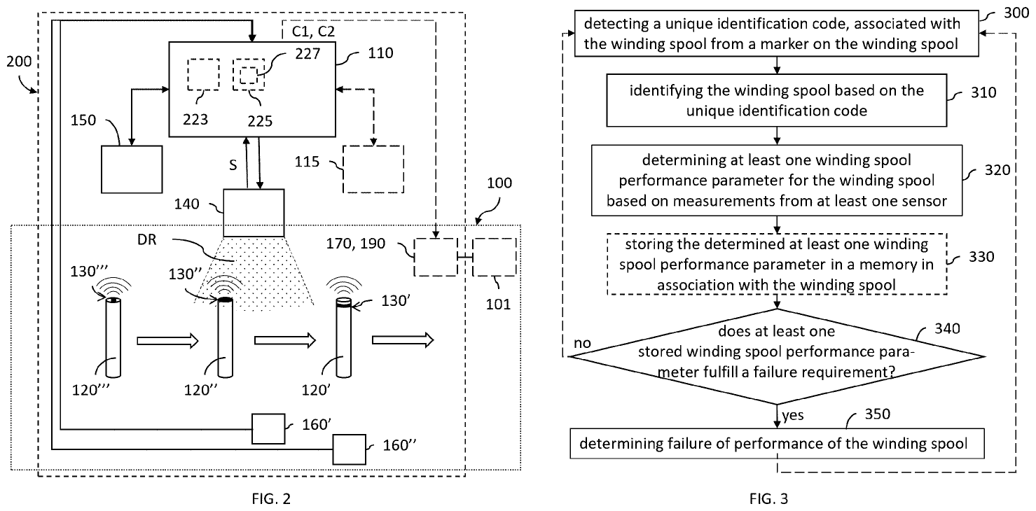

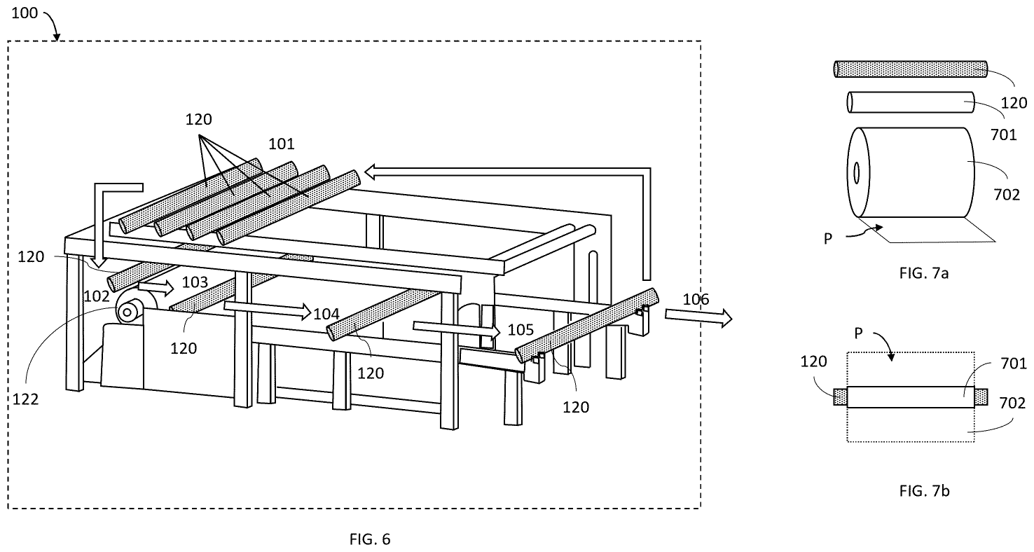

In a first aspect of the invention, there is provided a system for monitoring the performance of each of at least one winding spool in the reel section of a paper machine, which will now be described in connection with FIGS. 1 and 2, and also with reference to FIGS. 5 and 6.

To be able to keep the paper machine running continuously, the reel section must be able to quickly switch from winding a finished parent roll to an empty winding spool without stopping the flow of paper product. To accomplish this, each reel section will have two or more winding spools rotating through the process, in a so called winding cycle. In the context of the present disclosure, the winding cycle for a winding spool 120 is defined as either beginning when a winding spool 120 is identified in the primary arms 102 and ending when the same winding spool 120 is identified in the spool storage 101, or beginning when a winding spool 120 is identified in the spool storage 101 and ending when the same winding spool 120 is identified in the weighing station 104 or the inflation/deflation station 105 if the winding spool 120 is an inflatable spool and therefor passes this station. Typically, a winding spool 120 that is inflatable will after deflation, removal of the parent roll, and inflation be transferred back to the spool storage 101, which is then the end of the winding cycle for this type of winding spool 120. Other types of winding spools 120 will typically be transferred from the reel section 100 after the weighing station 104, together with the parent roll wound thereon, to a subsequent machine such as a winder, a rewinder, or a converter, for further processing. Winding spools 120 that are transferred to a subsequent machine may later re-enter the spool storage of a reel section in the same or another paper machine. Processing circuitry 110, as described herein in connection with the figures, may be connected to and perform the monitoring of winding spools described herein for more than one reel section. The processing circuitry 110 may therefore be configured to identify the individual winding spools 120, in any manner described herein, in the more than one reel section 100 and update the number of winding cycles each time the identified winding spool 120 finishes a winding cycle in any of the more than one reel sections 100 connected to the processing circuitry 110.

However, the winding cycle is per definition a cycle and may thus be said to start and end at any point along the cycle.

Updating of the number of winding cycles, i.e. adding 1 to the registered number of winding cycles for an identified winding spool 120, according to embodiments herein, is preferably done at the end of a winding cycle. This means that for the winding cycles according to the present context, the updating of the number of reel section winding cycles is preferably done at the weighing station 104, the inflation/deflation station 105, or the spool storage 101.

First, we turn to FIG. 2, which schematically discloses a system 200 for monitoring the performance of at least one winding spool 120 in the reel section 100 of a paper machine, according to one or more embodiments of the invention.

The system 200 comprises at least one winding spool 120, each of the at least one winding spool 120 having a respective marker 130 comprising information on a unique identification code, ID, associated with the winding spool 120. The system 200 further comprises a memory 150 accessible to the processing circuitry 110. The memory 150 may also be referred to as for example a storage or a database. That the memory 150 is accessible to the processing circuitry may mean that it is integrated in the system 200 comprising the processing circuitry 110, or that it is communicatively connected to the system 200 and more specifically to the processing circuitry 110 using any suitable wired or wireless communication method. The memory 150 is configured to receive and store at least one winding spool performance parameter and other relevant information, for example the location/section in the winding spool where the winding spool performance parameter was determined, in association with the unique identification code, ID, of the identified winding spool 120.

The system 200 further comprises at least one detector 140 configured to detect the respective marker 130 on each winding spool 120, wherein the at least one detector 140 is operatively connected to the reel section 100 and is positioned along a winding cycle of the at least one winding spool 120. Each detector 140 is typically directed towards a section of the winding cycle where the at least one winding spool 120 will pass and positioned such that the marker 130 of each winding spool 120 will enter the detection range DR of the detector 140 upon passing. Depending on the type of marker, each detector may comprise for example a QR code scanner, a bar code scanner, an RFID reader, an imaging sensor, a sensor within any other suitable spectrum of light, and/or any other suitable type of detector or sensing device configured to detect the marker in question.

The system 200 further comprises at least one sensor 160, in FIG. 2 exemplified by two sensors 160′ and 160″, configured to determine a parameter indicative of the performance of the winding spool 120 and processing circuitry 110 that is communicatively connected to the at least one detector 140 and the at least one sensor 160, as well as a memory 150 accessible to the processing circuitry 110. The memory 150 may also be referred to as a storage or a database. That the memory 150 is accessible to the processing circuitry may mean that it is integrated in the system 200 comprising the processing circuitry 110, or that it is communicatively connected to the system 200 and more specifically to the processing circuitry 110 using any suitable wired or wireless communication method.

Each of the at least one detector 140 is configured to, for each of the at least one winding spool 120, detect a unique identification code, ID, associated with the winding spool 120 from the respective marker 130 on the winding spool 120. The processing circuitry 110 is then configured to, for each of the at least one winding spool 120, identify the winding spool 120 based on the unique identification code, ID. The processing circuitry 110 is further configured to determine at least one winding spool performance parameter for the identified winding spool 120 based on measurements from one or more of the at least one sensor 160 and to, for each of the at least one winding spool 120, determine if there is a failure of the performance of the identified winding spool 120 based on if the determined at least one winding spool performance parameter fulfils a requirement indicative of failure of the performance of the winding spool 120. Determining if there is a failure of the performance of the identified winding spool 120 may also be referred to as determining that the winding spool 120 is faulty and in need of replacement or maintenance.

Suitably, the described system 200 thereby provides an automated solution for tracking winding spools for the purpose of assessing the properties of each identified winding spool itself, and further using the knowledge gained to draw conclusions on faulty spools, maintenance actions required, etc. As this achieves a reduction in both the need for manual labour and the downtime of the paper machine compared to previous solutions, embodiments herein lead to reduced time and cost for maintenance of the winding spools, the reel section and by extension the entire paper machine and paper mill. Advantageously, the reduction or even removal of manual monitoring and replacing of this with automated monitoring using embodiments described herein thereby further improves the accuracy of the maintenance of the winding spools in the reel section, and thereby also improves the entire production process of the paper machine and the paper mill. The resulting yield of the production process will be higher, due to less downtime due to both reduction of manual handling and more accurate maintenance, which contributes to maximizing utilization of the winding spools and also increasing the lifespan of other machine components that may be subjected to wear due to faulty winding spools.

The at least one performance parameter may comprise both measured information and previously stored, and retrieved, information in combination. The processing circuitry 110 may be configured to retrieve at least one performance parameter from the memory 150 and, for each of the at least one winding spool 120, determine at least one winding spool performance parameter for the identified winding spool 120 also based on the retrieved at least one performance parameter. Suitably, this allows historical data for the identified winding spool 120 previously determined and stored in association with the winding spool 120, to be taken into account. Thereby, it is also advantageously possible to identify changes over time and to use this information in the determination of whether there is a failure of the performance of the identified winding spool 120. Embodiments of the invention that stores information on each measured winding spool performance parameter in association with each identified winding spool, so that analysis may be made not only on the winding spool performance at a single point in time to find any immediate maintenance need, hence also enables finding changes and deterioration over time, trends, and further enable predicting future maintenance needs and the timing of when maintenance will become needed.

The requirement indicative of failure, which comprises at least one criterion (logic rule) to be fulfilled, is stored in the memory 150, or in another memory accessible to the processing circuitry 110 and can be received or retrieved therefrom by the processing circuitry 110. The requirement indicative of failure may be pre-set during production or initiation of the system 100, and/or it may be set or updated during operation based on input from a user interacting with a user interface connected to an input/output device 115 integrated in or communicatively coupled to the system 100.

The processing circuitry 110 may be configured to, for each of the at least one winding spool 120, identify the winding spool 120 based on the unique identification code, ID, by first receiving a detection signal S, S′, S″ from one of the at least one detector 140. The detection signal S, S′, S″ is indicative of the detected unique identification code, ID. The processing circuitry 110 is then configured to compare the unique identification code, ID, to a set of unique identification codes, ID_{1 . . . n}, stored in the memory 150, wherein each unique identification code in the set is stored in association with a respective unique winding spool 120. If a match is found between the detected unique identification code, ID, and a unique identification code in the set stored in the database, the processing circuitry 110 is further configured to identify the winding spool 120 as the winding spool associated with the matching unique identification code, IDₙ.

Parameters indicative of the performance of the winding spool 120 may also be referred to as winding spool performance parameter, or key performance indicators for the winding spools, and may comprise a selection of the number of cycles performed by the winding spool 120, vibrations in a component or part of the reel section caused by the winding spool 120, a pressure in the winding spool 120, if the winding spool is an inflatable core shaft and/or the number or ratio of unsuccessful turn-ups associated with the winding spool 120.

In one or more embodiment, the processing circuitry 110 may be configured to determine that there is a failure of the performance of the identified winding spool 120 if a determined number of cycles performed by the winding spool 120 in the reel section 100 exceeds a pre-set maximum number of cycles. In other words, if the determined number of cycles performed by the winding spool 120 exceeds the pre-set maximum number of cycles, the identified winding spool 120 is determined to be faulty. Advantageously, a winding spool 120 that is or soon risk becoming worn out and introducing errors in the process, is thereby automatically identified by the system 200 and can be maintained, replaced or removed, manually or automatically, from the reel section 100. The pre-set maximum number of cycles is suitably set to the maximum number of cycles that the winding spool 120 is allowed to perform before the winding spool 120 needs to be subjected to maintenance, i.e., be removed, replaced, and/or manually checked for wear and damage, to ensure continued proper performance of the reel section. The pre-set maximum number of cycles is pre-set in the system during setup or initiation of the monitoring system, for example automatically set according to a standard setting for the type of winding spool 120, or by being entered manually by a user interacting with an input device 115 via a user interface. The number of winding cycles in the reel section is increased by one each time a specific winding spool 120 is identified at a specific one of the at least one detector 140, to indicate that the winding spool 120 has performed one more winding cycle. The number of cycles performed by a specific winding spool 120 may for example be increased by one each time the specific winding spool enters the range of a detector 140 arranged at the primary arms 102, at the secondary arms 103, or at the weighing station 104 of the reel section 100, or at any other selected suitable location along the winding cycle.

Alternatively, or additionally, the processing circuitry 110 may be configured to determine that there is a failure of the performance of the identified winding spool 120 if vibrations caused by the winding spool 120 in a certain part of the reel section 100 exceeds a vibration threshold value indicative of a highest allowed vibration value for balanced winding spools 120 in relation to the respective part of the reel section 100. In these embodiments, the at least one sensor 160 comprises at least one vibration sensor or acoustic sensor, and the processing circuitry 110 is configured to determine at least one vibration value indicative of vibrations in a component or part of the reel section 100 caused by the winding spool 120 based on one or more measurement from the at least one vibration sensor. The processing circuitry 110 is in these embodiments further configured to determine that there is a failure of the performance of the identified winding spool 120 by comparing each of the at least one vibration value to the respective vibration threshold value for the part or parts of the reel section 100. The vibrations may be measured directly, using a vibration sensor, or indirectly by measuring the noise level using an acoustic sensor, the thresholds in this case being defined in Db. The vibrations caused by a specific winding spool 120 on one or more parts of the reel section 100 may be monitored at one time instance and compared to a fixed vibration threshold value. Alternatively, the vibrations caused by a specific winding spool 120 on one or more parts of the reel section 100 may be monitored over time, typically once per winding cycle, and the vibration threshold value may be relative and indicate either a highest allowed vibration value for a balanced winding spool 120 in relation to the respective part of the reel section 100, possibly also dependent on the number of winding cycles performed by the winding spool 120, or the highest allowed increase rate of vibrations for a balanced winding spools 120. Advantageously, a winding spool 120 that is or soon risk becoming unbalanced and introducing errors in the process, is thereby automatically identified by the system 200 and can be maintained, replaced or removed, manually or automatically, from the reel section 100.

In one or more embodiment, the primary arms 102 may comprise a first and a second loaded arm (not shown in the figures) which are configured to hold the winding spool 120 and press it against the web on the reel drum 122 or reel belt for the turn-up. If the pressures differ more than an allowed amount (threshold), this is an indicator that the winding spool 120 is unbalanced. The first loaded arm is in these embodiments arranged to hold the winding spool 120 at or close to a first end of the winding spool 120 that is facing the drive side (back side) of the reel section 100, and the second loaded arm is arranged to hold the winding spool 120 at or close to a second, opposite, end of the winding spool 120 that is facing the tending side (operator side) of the reel section 100. The loaded arms are pressurized by a first and second cylinder, for example being hydraulic cylinders, (not shown in the figures), which are also comprised in the primary arms 102. As an alternative, or in addition, to the above manner of detecting an unbalanced winding spool 120, an unbalanced winding spool 120 may in these embodiments be identified by measuring and comparing the respective pressure in the first and second cylinder. For a balanced winding spool 120, the pressure applied to pressurize the first and second loaded arm should be the same. The processing circuitry 110 may in these embodiments be configured to determine that there is a failure of the performance of the identified winding spool 120 if the difference in pressure applied by the first and second cylinders to pressurize the respective first and second loaded arms exceeds a pressure difference threshold value indicative of a highest allowed pressure difference for balanced winding spools 120. In these embodiments, the at least one sensor 160 comprises at least one first pressure sensor connected to and configured to measure the pressure in or applied by the first cylinder and at least one second pressure sensor connected to and configured to measure the pressure in or applied by the second cylinder. The processing circuitry 110 is then configured to receive pressure measurements from the at least one first pressure sensor and the at least one second pressure sensor and determine the difference in pressure in or applied by the first cylinder and the second cylinder based on the received measurements. The processing circuitry 110 is in these embodiments further configured to determine that there is a failure of the performance of the identified winding spool 120 if the determined difference in pressure exceeds the pressure difference threshold.

Advantageously, a winding spool 120 that is or soon risk becoming unbalanced and introducing errors in the process, is thereby automatically identified by the system 200 and can be maintained, replaced or removed, manually or automatically, from the reel section 100.

If the identified winding spool 120 is an inflatable core shaft, the at least one sensor 160 may comprise at least one pressure sensor configured to measure a pressure in the inflatable core shaft using any pressure sensing technology, including, but not limited to ultrasonic technology, acoustic imaging technology, electromagnetic technology, optical technology or strain-gauge technology. The at least one pressure sensor is configured to send the measured pressure value to the processing circuitry 110. In these embodiments, the requirement indicative of failure of the performance comprises, in alternative or addition to the other embodiments described herein, that the winding spool 120 has a valve leakage. The processing circuitry 110 is in these embodiments configured to determine that there is a failure of the performance of the identified winding spool 120 if the measured pressure value deviates more than an allowed tolerance from a reference pressure value for the inflatable core shaft. In this embodiment, the winding spool 120 is an inflatable core shaft. Advantageously, a winding spool 120 that has a valve leakage and risk introducing errors in the process, is thereby automatically identified by the system 200 and can be maintained, replaced or removed, manually or automatically, from the reel section 100. All pressure values measured using the at least one pressure sensor, preferably at the inflate/deflate station in the reel section, are stored in the memory 150 in association with the identified core shaft. Of course, any combination of at least one stored pressure value for the core shaft and a currently measured pressure value for the core shaft at the present location of the winding spool in the winding cycle, including changes in pressure derived from pressure values measured over time, may be used as basis to determine if the core shaft has a valve leakage. It is determined that the core shaft has a valve leakage if the determined pressure value or values assessed deviate from the reference pressure value by more than an allowed tolerance. The reference pressure value may be set to a previously measured pressure of the core shaft, indicating of the pressure has decreased since the last measurement, or be a pre-set reference value for the type of core shafts used. The reference pressure value is stored in and retrieved from the memory 150.

In some embodiments, the pressure in the inflatable core shaft may be checked once every winding cycle, by measuring the pressure at the inflation/deflation station 105 right before deflation, whereafter the inflatable core shaft is deflated and then inflated with a new core mounted thereon. In this embodiment, a second pressure measurement is performed directly after inflation and this pressure measured directly after inflation is set as the reference value. Thereby, it can advantageously be determined if the pressure in the inflatable core shaft decreases more than expected during a winding cycle, which indicates a valve leakage.

Alternatively, or additionally, the requirement indicative of failure of the performance of the winding spool 120 may comprise that the ratio of unsuccessful turn-ups for the winding spool 120 is equal to or exceeds a pre-set maximum unsuccessful turn-up ratio. In these embodiments, the processing circuitry 110 is configured to determine the number of unsuccessful turn-ups associated with the winding spool 120 and compare it to the total amount of winding cycles performed by the winding spool 120 to determine the unsuccessful turn-up ratio for the winding spool 120. The processing circuitry 110 is further configured to determine that there is a failure of the performance of the identified winding spool 120 if the unsuccessful turn-up ratio for the winding spool 120 is equal to or exceeds the pre-set maximum unsuccessful turn-up ratio. Advantageously, a winding spool 120 that for any reason is the cause of unsuccessful turn-ups, introducing costly and time-consuming halting of the process and a reduction in yield, is thereby automatically identified by the system 200 and can be maintained, replaced or removed, manually or automatically, from the reel section 100. As is known in the art, an unsuccessful turn-up is in a very high degree of cases due to a faulty core shaft. In this embodiment the number of unsuccessful turn-ups or the ratio of unsuccessful turn-up, calculated as a ratio between the number of unsuccessful turn-ups and the total amount of winding cycles performed by the winding spool 120, is included in the at least one winding spool performance parameter for the identified winding spool 120 based on measurements from at least one sensor 160. The one or more sensor 160 in this case comprises a sensor configured to detect a sheet-break, in any known manner. The number of winding cycles performed by the winding spool 120 is increased by 1 every time the winding spool is detected by one selected detector 140 in the winding cycle and identified by the processing circuitry 110, and the current number of winding cycles is then stored in the memory 150 in association with the identified winding spool 120. Hence, the number of winding cycles for each identified winding spool 120 can be retrieved by the processing circuitry 110 from the memory 150 in order for the processing circuitry 110 to determine the ratio of un-successful turn-ups associated with the winding spool 120. The memory is further configured to store, and the processing circuitry 110 is configured to retrieve from the memory 150, the pre-set maximum unsuccessful turn-up ratio for comparison. The pre-set maximum unsuccessful turn-up ratio may be set once, for example during production or initiation, or updating of the present maximum unsuccessful turn-up ratio may be enabled via the user interface connected to the input/output device 115 communicatively coupled to the processing circuitry 110.

If it is determined that there is a failure of the performance of a winding spool 120 in the reel section, in accordance with any embodiment of the invention described herein, the winding spool may further be removed or replaced, manually or automatically. Suitably, an improved maintenance scheme is thus provided. Information regarding the failure may be presented to an operator via a user interface connected to the input/output device 115, possibly together with information on predicted maintenance needs, thereby prompting the operator to initiate the manual or automatic maintenance, replacement or removal of the faulty winding spool 120. An operator of the system 200 may thereby advantageously be alerted regarding maintenance actions to be taken in the form of removing or replacing a winding spool 120, and/or the system 200 may automatically perform these actions, if a winding spool 120 is after repeated tracking through the winding cycle determined to be faulty due to it for example being out of balance (causing vibrations that the system has measured and stored information about), close to its maximum cycle amount (iteratively updating number of cycles based on identification of the winding spool in certain position in the winding cycle), and/or having a valve leakage (measured at the inflate/deflate section).

Advantageously, this information enables an operator to easily perform the maintenance, replacement, removal, etc. needed based on timely and precise information. As illustrated in FIG. 2, if it is determined that there is a failure of the performance of the winding spool 120, the processing circuitry 110 may be configured to generate a first control signal C1 configured to cause an actuator 170 of the reel section 100 to remove the winding spool 120 from the reel section. As further illustrated in FIG. 2, the processing circuitry 110 may in these embodiments further be configured to generate a second control signal C2 configured to cause the same or another actuator 170, 190 of the reel section to replace the removed winding spool with a new winding spool from a winding spool storage, or spool storage, 101. The winding spool storage 101 comprises winding spools 120 that are known to be working, i.e., not faulty. The winding spools 120 in the spool storage 101 may be faultless with regard to all the winding spool performance parameters assessed in different embodiments herein, or not quite faultless but deemed acceptable for operation. The storage of working, possibly faultless, winding spools is suitably arranged in connection with the reel section 100 and accessible to the actuator 170, 190 that is configured to replace any removed faulty winding shafts 120.

In some embodiments, a value of the weight for each unique winding spool 120 has previously been measured and stored in the memory 150 in association with the respective unique winding spool. The weight of the unique winding spool has in these cases been determined before the winding spool enters the winding cycle or before it is mounted in the reel section. The memory 150 is consequently configured to store a value of the weight of each unique winding spool 120 in association with the respective unique winding spool 120. In these embodiments, the processing circuitry 110 may be configured to retrieve the weight of the identified winding spool 120 from the memory 150, determine a desired nip load in (a part of) the reel section 100 based on the weight of the identified winding spool 120 and control the nip load in (the part of) the reel section 100 based on the desired nip load. Advantageously, using the actual, measured, weight of the identified winding spool 120, a more accurate determination of the optimal nip load can thus be provided compared to known solutions. Alternatively, or additionally, the system 200 according to these embodiments further comprises a weighing instrument (not shown in the figures), such as a scale or the like, that is arranged at the weighing station 104 and that is communicatively connected to the processing circuitry 110. The weighing instrument is configured to determine the total weight of a winding spool 120 with a paper product P wound thereon when the winding spool 120 is in the weighing station 104 in the reel section 100. The processing circuitry is in this case further configured to receive or retrieve the determined total weight in the processing circuitry 110 from the weighing instrument, receive or retrieve the weight of the winding spool 120 from the memory 150, and determine the exact weight of the paper product P wound on the winding spool 120 by subtracting the retrieved weight of the winding spool 120 from the determined total weight. Thereby a more accurate determination of the weight of the paper product is achieved compared to when a standard weight is assumed for the winding spool, leading to a more exact determination of when a goal weight, or goal amount of paper product, has been wound on the parent roll and it is time to perform a turn-up.

If a winding spool performance parameter is measured by a sensor 160 at the location where the winding spool 120 has currently been identified, information on the determined identity of the winding spool 120, i.e. the detected ID or identity information derived based on the ID, and the determined, measured, at least one winding spool performance parameter, together with information on the location where the winding spool 120 has been identified if this is relevant in relation to the at least one performance parameter, is sent to the memory 150 for storage and further processing.

Assigning of a unique identification code, ID, to the winding spool 120 may include providing, or applying, a marker 130 to the winding spool 120 in the form of graphic information (a QR code, a bar code, a unique set of alphanumeric symbols, a unique pattern, symbol(s) and/or color or color combination, or the like), electronic information in the form of an active or passive sender, for example an RFID tag or the like, and/or magnetic band information, and storing the unique identification code, ID, in the memory 150 in association with the respective unique winding spool 120 to which the ID is assigned. In other words, each winding spool 120 may be marked electronically by applying a first electronic label or tag, for example an RFID medium or tag, or another type of marker that can be detected by a detector as described herein. In the case of an electronic or magnetic medium, the assigning may include a programming step for assigning said ID of the marker medium, for example an RFID tag, which takes place before applying the marker to said at least one winding spool 120.

Each marker 130 may be applied for example on an outer edge of the respective winding spool 120, or in any other suitable location that enables it to be viewed, sensed, read, or otherwise detected by the at least one detector 140, i.e. in any position on the winding spool 120 that enables it to enter the detection range of the detector(s) arranged to detect it along the winding cycle. The markers may be applied in any suitable manner, depending on the type of marker. In some embodiments, the system 200 further comprises a marking device configured to apply the marker to the winding spool, prior to detecting the unique identification code associated with the winding spool from the marker.

The system 200 is in some embodiments configured to perform the monitoring of the performance of the at least one winding spool 120 for each winding spool 120 that enters the detection range DR of one of the at least one detectors 140. Specifically, entering the detection range DR of a detector 140 means that the marker 130 on the winding spool 120 appears in the detection range DR, which may also be referred to as detection area, sensing area or sensing range, the detector 140. In any embodiment herein, that a detector 140 is positioned and arranged to detect a winding spool 120 present at a certain location, such as any of the reel sub-sections including spool storage 101, primary arms 102, secondary arms 103, weighing station 104 or inflation/deflation station 105, means that it is positioned such that the part of the winding spool 120 that comprises the marker 130 will enter the detection range DR of the detector as it passes into, is present in, or passes out of the certain location. In FIG. 2 this is illustrated by the detector 140 having a detection range DR in which the marker 130″ of the winding spool 120″ is present, hence the detector 140 can detect the winding spool 120″ from the marker 130″. Similarly, that a winding spool 120 is identified to be in for example the primary arms 102 means that it is detected by, i.e. within the detection range of, a detector 140 located at the primary arms 102. The markers 130′ and 130″ of winding spools 120′ and 120″, respectively, are outside the detection range DR of the detector 140 in FIG. 2 and can therefore currently not be detected by the detector 140. A detector may also be referred to as for example a reader, a sensor, a scanning device, or any other suitable device configured to detect, read, sense or scan information from a marker. The positions, shapes and sizes of the markers 130′, 130″ and 130″ on the respective winding spools 120′, 120″ and 120″' in FIG. 2 are non-limiting examples shown for illustrational purposes only.

In some embodiments, at least one of the at least one detector 140 may be configured to, alternatively or in addition to detecting the ID of a winding spool 120, detect a unique core identification code, ID_{CORE}, associated with a core mounted on the winding spool 120, from a core marker on the core. The core marker may be any type of marker described herein in connection with the marker 130. FIG. 7a shows a schematic perspective view of the separate parts of a winding spool 120, a core 701 and a roll 702 of paper product P, and FIG. 7b shows a schematic side view of an assembly comprising a winding spool 120, a core 701 and a roll 702 of paper product P. The core marker is not shown in the figures, but the skilled person realises that it may be applied to the core 701 in any suitable manner and at any suitable position. The processing circuitry 110 is in these embodiments further configured to identify the core 701 based on the unique core identification code, ID_{CORE}, and to determine if there is a failure of the performance of the identified winding spool 120 also based on stored or measured information on the performance of the core. By including information on the performance of the core, any fault relating to the core and not to the winding spool 120 can be determined and false negatives that would otherwise lead to a determination that there is a failure of the performance of the identified winding spool 120 can advantageously be avoided. For example, if it is determined that at least one winding spool performance parameter fulfils a requirement indicative of failure of the performance of the winding spool 120 or, according to embodiments herein, and it is also determined that the core mounted on the winding spool 120 is faulty, this may indicate that it is in fact the core causing the issue and not the winding spool 120. Similarly, if a problem appearing to be related to the performance of the winding spool 120 is detected during one winding cycle, but the same problem is not detected for the same winding spool 120 during the next winding cycle, i.e., after the core and paper roll thereon has been changed, it may be concluded that the problem was due to the previous core and not the winding spool 120.

Thereby, an even more reliable determination of whether there is a failure of the performance of the identified winding spool 120 is achieved.

With reference to FIGS. 1, 5 and 6, we will now describe how each winding spool moves through a winding cycle in the reel section. The direction of the winding cycle is illustrated in FIG. 6 by the arrows from 101 to 102, from 102 to 103, etc. In FIGS. 1 and 6, the winding spools 120 are shown without paper product wound thereon. This is for illustrational purposes only, to more easily illustrate how the winding spools move though the winding cycle.

As shown in FIGS. 1 and 6, the reel section 100 comprises a number of sub-sections including a spool storage 101, primary arms 102, secondary arms 103, a weighing station 104 and possibly an inflation/deflation station 105 if core shafts/inflatable winding spools are used.

Using a lowering arm, or any other suitable actuator, an empty winding spool 120 from the spool storage 101 may be loaded onto the primary arms 102 above a reel drum 122, as shown in the example of FIGS. 1 and 6, or onto a reel belt. When a parent roll is finished (for example determined by it reaching its maximum diameter) on the previous winding spool 120 that is located at the secondary arms 103, the primary arms 102 will lower the new, empty, winding spool 120 into contact with the reel drum 122, or the reel belt, and a machine (not shown in the figures) operatively connected to the reel drum 122 or the reel belt will run a tape, apply glue, or the like along the moving sheet of paper product, swiftly tearing it and attaching incoming paper product onto the new winding spool 120. The new winding spool is then lowered onto the secondary arms 103. After the turn-up, the secondary arms 103 then steadily guide the winding spool 120 away from the reel drum 122, or reel belt, as the paper product is wound on the core of the winding spool 120 and the diameter of paper product on the winding spool 120 increases. When the parent roll on the present winding spool 120 at the secondary arms is finished, turn-up is again performed and the present winding spool 120 with the finished parent roll wound thereon is kicked out and transferred to the weighing station 104. After weighing at the weighing station 104, the winding spool 120 may proceed to the inflation/deflation station 105 downstream of the weighing station 104 if inflation and/or deflation is to be performed. Thereafter, the winding spool 120 may be transferred from the inflation/deflation station 105 back to the spool storage 101, for example using an overhead crane, or any other suitable actuator. From the spool storage 101 the winding spool 120 can be returned to the primary arms 102, thereby entering a new winding cycle. Alternatively, if the winding spool 120 is not inflatable, the winding spool 120 is transferred from the end station, for example the weighing station 104 or a separate station after the weighing station 104, to a subsequent machine such as a winder, a rewinder and/or a converter for further processing of the parent roll wound thereon. Alternatively, if it has been determined at any time during the winding cycle that there is a failure of the performance of the present winding spool 120, the winding spool 120 may be removed from the reel to be adjusted, maintained, or discarded. The transfer of a winding spool 120 to a subsequent machine for further processing of the parent roll or removal of a winding spool 120 is illustrated in FIG. 6 by the arrow 106. Preferably, the winding spool 120 is removed, manually or automatically by sending a control signal to a removing actuator, from the inflation/deflation station 105 or the spool storage 101 or somewhere between these, including at subsequent machines performing further processing of the parent roll, in other words after the parent roll has been removed from the winding spool 120 and before the winding spool 120 is re-entered into the primary arms 102 of the same or another reel section 100.

Turning now to FIG. 1, there are shown two detectors 140′, 140″ configured to detect a unique identification code, ID, associated with the winding spool 120 from a marker 130 on the winding spool 120 as described in connection with FIG. 2. The detectors 140′, 140″ are configured to generate a respective detection signal S′, S″ and to send these to the processing circuitry 110 for interpretation and further processing. The detectors 140′, 140″ in FIG. 1 are for ease of illustration only two and they are shown as located at the spool storage 101 and the inflation/deflation station 105. However, in any embodiment herein, there may be at least one detector 140 located at one or more of the spool storage 101, the primary arms 102, the secondary arms 103, the weighing station 104 and possibly an inflation/deflation station 105.

FIG. 5 is a process flow illustrating how the at least one winding spool moves through the winding cycle in the reel section and how information is sent between system components. Depending on how many detectors are arranged at different positions in the reel section, a selection of the checking, or detection, steps 502, 506, 510, 514 and 522 may be performed. The process flow comprises:

In step 502: Checking, using a first detector located at the primary arms 102, if a winding spool 120 is present in the primary arms 102.

The checking of step 502 is done using a first detector (not shown in the figures) located at the primary arms 102, which is positioned and arranged to detect a winding spool 120 present in the primary arms 102 by detecting a unique identification code, ID, associated with the winding spool 120 from a marker 130 on a winding spool 120 in the primary arms 102.

Once the first detector has detected the winding spool 120 at the primary arms 102, information indicative of the unique identification code, ID, associated with the winding spool 120 is sent from the first detector to the processing circuitry 110 in the form of a first detection signal indicative of the unique identification code, ID.

The processing circuitry 110 is configured to identify the winding spool 120 based on the first detection signal, as described herein. Based on further information comprised in the first detection signal indicative of the location of the winding spool 120, or information about the identity of the first detector and its location within the reel section, the processing circuitry 110 may further be configured to determine that the identified winding spool is at the primary arms 102. If a winding spool 120 is thus determined to be present in the primary arms 102, the process continues in step 504 when it is time for the next turn-up.

In step 504: Transferring the winding spool 120 from the primary arms 102 to the secondary arms 103.

In step 506: Checking if a winding spool 120 is present in the secondary arms 103.

The checking of step 506 is done using a second detector 140 (not shown in the figures) located at the secondary arms 103 and being positioned and arranged to detect a winding spool 120 present in the secondary arms 103 by detecting the unique identification code, ID, associated with the winding spool 120 from the marker 130 on the winding spool 120. Information on the unique identification code, ID, associated with the winding spool 120 is sent from the second detector 140 to the processing circuitry 110 along with information on the location where the winding spool 120 was detected in any manner described in connection with step 502.

At the secondary arms, paper product is wound onto the winding spool 120, thereby creating a parent roll. If a winding spool 120 is present in the secondary arms 103 and winding is completed, the process continues in step 508.

In step 508: Transferring the winding spool 120 from the secondary arms 103 to the weighing station 104.

In step 510: Checking if a winding spool 120 is present in the weighing station 104.

The checking of step 510 may be done using a third detector 140 (not shown in the figures) located at the weighing station 104 and being positioned and arranged to detect a winding spool 120 present in the weighing station 104 by detecting the unique identification code, ID, associated with the winding spool 120 from the marker 130 on the winding spool 120. Information on the unique identification code, ID, associated with the winding spool 120 is sent from the second detector 140 to the processing circuitry 110 along with information on the location where the winding spool 120 was detected in any manner described in connection with step 502.

After the weighing station 104, if the winding spool 120 is an inflatable winding spool 120, optionally checked in a Step 511, the process continues in optional step 512. Alternatively, if the winding spool 120 is not an inflatable winding spool 120, the process continues in optional step 515.

In an optional step 512: Transferring the winding spool 120 from the weighing station 104 to the inflation/deflation station 105.

This step is performed if the winding spool 120 is an inflatable winding spool.

In an optional step 514: Checking if a winding spool 120 is present in the inflation/deflation station 105.

The checking of step 514 may be done using a fourth detector 140, for example the detector 140′ in FIG. 1, located at the inflation/deflation station 105 and being positioned and arranged to detect a winding spool 120 present in the inflation/deflation station 105 by detecting the unique identification code, ID, associated with the winding spool 120 from the marker 130 on the winding spool 120. Information on the unique identification code, ID, associated with the winding spool 120 is sent from the second detector 140 to the processing circuitry 110 along with information on the location where the winding spool 120 was detected in any manner described in connection with step 502.

In the example shown in FIG. 1, the marker 130 is attached on or near, or integrated in or near, the end of the winding spool 120 that is facing the fourth detector 140′. As shown in FIG. 1, and as is true for any or all detectors 140 in embodiments of this invention, the fourth detector is configured to generate a detection signal comprising information on the unique identification code, ID, and information on the location of the detected winding spool 120 and/or the fourth detector. In other words, the signal is indicative of the identity and position (“in the inflation/deflation station”) of the detected winding spool 120. In FIG. 1, the fourth detection signal is exemplified as the detection signal S′.

In an optional step 515: Transferring the winding spool 120 from the reel section 100 to a subsequent machine for further processing.

This step is performed if the winding spool 120 is not an inflatable winding spool, i.e. if the paper product of the parent roll is wound directly on the winding spool 120 instead of on a removable core.

The subsequent machine may for instance be a winder, a rewinder or a converter.

Unless the winding spool 120 is found to be faulty at any time after step 515, it may later be reintroduced into a new winding cycle in Step 520, in the same or another reel section 100.

In step 516: determining, using the processing circuitry 110, if there is a failure of the performance of the identified winding spool 120.

Steps 516 does not have to be performed in sequence after step 514. Rather, the check of whether the identified winding spool 120 is faulty or need maintenance may be performed at or between any step(s) of the process flow.

As shown in the figure, information gathered during any or all of the checking steps 502, 506, 510, 514 and/or 522 may be used as basis for the determination in step 516 of whether the there is a failure of the performance of the identified winding spool 120.

If it is determined that there is a failure of the performance of the identified winding spool 120, the process flow continues in step 518.

In step 518: Removing the identified winding spool 120 from the reel section. Step 518 of removing the winding spool 120 from the reel section, in response it being determined that there is a failure of the performance of the identified winding spool 120, may be performed between any two steps in the process flow of FIG. 5. However, it is preferably done when there is no paper product wound on the winding spool. The identified faulty winding spool 120 is preferably removed from either the inflation/deflation station 105, after removal of a finished parent roll from the winding spool 120, or from the spool storage 101, before the winding spool 120 enters a new winding cycle.

Removal of the winding spool 120 may be automatic and may be done using any suitable actuator, for example an overhead crane or the like, controlled in response to a control signal generated by the processing circuitry 110. Alternatively, removal of the winding spool 120 may be performed manually or by manually controlling an actuator, such as an overhead crane or the like.

In step 520: Transferring the winding spool 120 from the inflation/deflation station 105 to the spool storage 101.

In step 522: Checking if a winding spool 120 is present in the spool storage 101.

The checking of step 522 may be done using a fifth detector 140, for example detector 140″ in FIG. 1, located at the inflation/deflation station 105 and being positioned and arranged to detect a winding spool 120 present in the inflation/deflation station 105 by detecting the unique identification code, ID, associated with the winding spool 120 from the marker 130 on the winding spool 120. Information on the unique identification code, ID, associated with the winding spool 120 is sent from the second detector 140 to the processing circuitry 110 along with information on the location where the winding spool 120 was detected in any manner described in connection with step 502.

In the example shown in FIG. 1, the marker 130 is attached on or near, or integrated in or near, the end of the winding spool 120 that is facing the fifth detector 140″. As shown in FIG. 1, and as is true for any or all detectors 140 in embodiments of this invention, the fifth detector is configured to generate a detection signal comprising information on the unique identification code, ID, and optionally information on the location of the detected winding spool 120 and/or the fourth detector. In other words, the signal is indicative of the identity and optionally the position (“in the spool storage”) of the detected winding spool 120. In FIG. 1, the fifth detection signal is exemplified as the detection signal S″.

In step 524: Transferring the winding spool 120 from the spool storage 101 to the primary arms 102.

Thereby, the winding cycle is completed and the process flow starts over from step 502.

Alternatively, or additionally, to position information being included in the detection signal of any of the detectors described in connection with FIG. 1, 2, 5 or 6, the position of the winding spool 120 may be obtained via signals sent to the processing circuitry 110 from one or more proximity switches or proximity sensors (not shown in the figures) placed across the reel section.

### Method Embodiments

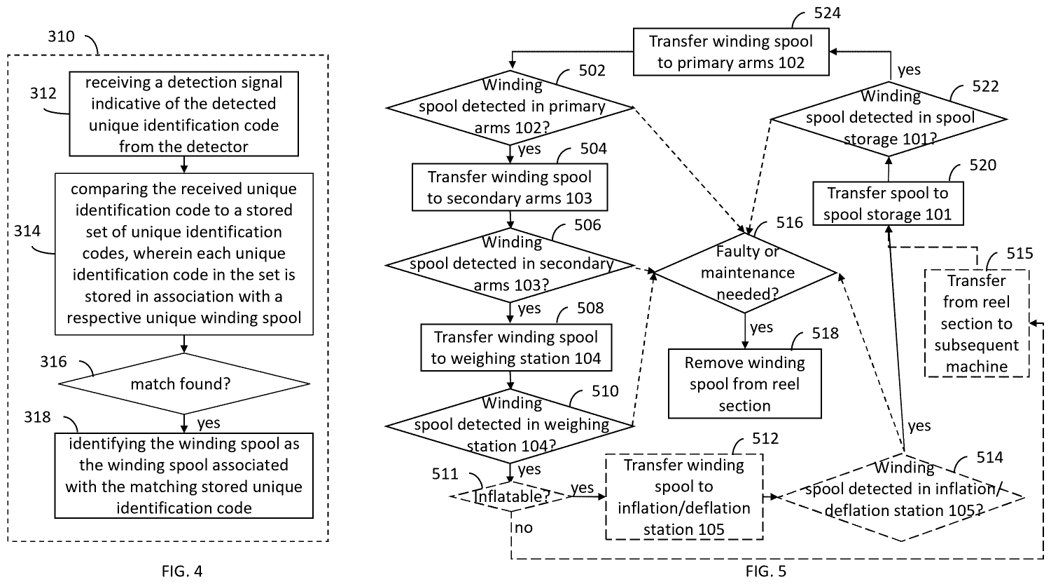

In a second aspect, illustrated by FIGS. 3 and 4, the invention is realized by a computer implemented method for monitoring the performance of at least one winding spool 120 in the reel section 100 of a paper machine, the reel section 100 being operatively connected to at least one detector 140 configured to detect a respective marker 130 on each winding spool 120, wherein the at least one detector 140 is positioned along a winding cycle of the at least one winding spool 120.

The method illustrated in FIG. 3 comprises, for each winding spool 120:

In step 300: detecting a unique identification code, ID, associated with the winding spool 120 from a marker 130 on the winding spool 120, using at least one of the at least one detector 140.

In step 310: identifying the winding spool 120 based on the unique identification code, ID, using processing circuitry 110 communicatively connected to the detector 140.

Identifying the winding spool 120 based on the unique identification code,

ID, using the processing circuitry 110, may comprise: receiving, in the processing circuitry 110, a detection signal S, S′, S″ from the detector 140, the detection signal S, S′, S″ being indicative of the detected unique identification code, ID; comparing, using the processing circuitry 110, the unique identification code, ID, to a set of unique identification codes, ID_{1 . . . n}, stored in the memory 150, wherein each unique identification code in the set is stored in association with a respective unique winding spool 120; and if a match is found between the detected unique identification code, ID, and a unique identification code in the set stored in the database, identifying the winding spool 120 as the winding spool associated with the matching unique identification code, IDₙ, using the processing circuitry 110.

In step 320: determining, using the processing circuitry 110, at least one winding spool performance parameter for the identified winding spool 120 based on measurements from at least one sensor 160.

Determining at least one winding spool performance parameter for the identified winding spool 120 may comprise using at least one sensor 160 configured to determine a parameter indicative of the performance of the identified winding spool 120. Alternatively, or additionally, determining at least one winding spool performance parameter for the identified winding spool 120 may comprise receiving or retrieving, by the processing circuitry 110, at least one previously measured and stored performance parameter indicative of the performance of the identified winding spool 120 from the memory 150. The at least one performance parameter may thus comprise both measured information and previously stored, and retrieved, information in combination.

In an optional step 330: storing the determined at least one winding spool performance parameter in association with the unique identification code,

ID, of the identified winding spool 120 in a memory 150 accessible to the processing circuitry 110.

In step 340: checking if at least one winding spool performance parameter fulfils a requirement indicative of failure of the performance of the winding spool 120.

The requirement indicative of failure of the performance of the winding spool 120 may comprise that the number of cycles performed by the winding spool 120 is equal to or exceeds a pre-set maximum number of cycles. In these embodiments, the determined at least one winding spool performance parameter comprises the number of cycles performed by the winding spool 120, and determining, using the processing circuitry 110, that there is a failure of the performance of the identified winding spool 120 if the determined number of cycles performed by the winding spool 120 exceeds the pre-set maximum number of cycles.

Alternatively, or additionally, the requirement indicative of failure of the performance of the winding spool 120 may comprise that the winding spool 120 is out of balance. In these embodiments, determining, using the processing circuitry 110, at least one winding spool performance parameter for the identified winding spool 120 based on measurements from at least one sensor 160 comprises determining at least one vibration value indicative of vibrations in a component or part of the reel section caused by the winding spool 120, based on one or more measurement from the at least one vibration sensor, and determining, using the processing circuitry 110, that there is a failure of the performance of the identified winding spool 120 comprises comparing each of the at least one vibration value to a respective vibration threshold value indicative of a highest allowed vibration value for balanced winding spools 120.

In embodiments wherein the winding spool 120 is an inflatable core shaft, the requirement indicative of failure of the performance of the winding spool 120 may alternatively, or additionally, may comprise that the winding spool 120 has a valve leakage. In these embodiments, determining, using the processing circuitry 110, at least one winding spool performance parameter for the identified winding spool 120 based on measurements from at least one sensor 160 comprises determining a pressure in the inflatable core shaft using at least one pressure sensor, and determining, using the processing circuitry 110, that there is a failure of the performance of the identified winding spool 120 comprises comparing the determined pressure to a pre-set reference pressure value for the winding spool 120.

Alternatively, or additionally, the requirement indicative of failure of the performance of the winding spool 120 may comprise that the ratio of unsuccessful turn-ups for the winding spool 120 is equal to or exceeds a pre-set maximum unsuccessful turn-up ratio. In these embodiments, determining, using the processing circuitry 110, at least one winding spool performance parameter for the identified winding spool 120 based on measurements from at least one sensor 160 comprises determining the number of unsuccessful turn-ups associated with the winding spool 120, and comparing it to the total amount of winding cycles performed by the winding spool 120 to determine the at unsuccessful turn-up ratio for the winding spool 120, and determining, using the processing circuitry 110, that there is a failure of the performance of the identified winding spool 120 comprises comparing the unsuccessful turn-up ratio for the winding spool 120 to the pre-set maximum unsuccessful turn-up ratio.

If at least one winding spool performance parameter fulfils a requirement indicative of failure of the performance of the winding spool 120, the method continues in step 350.

In step 350: determining, using the processing circuitry 110, that there is a failure of the performance of the identified winding spool 120.

If it is determined that there is a failure of the performance of the winding spool 120, the method may further comprise generating, using the processing circuitry 110, a first control signal C1 configured to cause an actuator 170 of the reel section 100 to remove the winding spool 120 from the reel section. In some of these embodiments, the method may further comprise generating a second control signal C2 configured to cause the same or another actuator 170, 190 of the reel section to replace the removed winding spool with a new winding spool from a winding spool storage 101.

The method may be performed repeatedly, as indicated by the dashed arrows leading back to step 300 from step 350 and also from step 340, in the case that no winding spool performance parameter is found to fulfil a requirement indicative of failure of the performance of the winding spool 120. The method may be performed for each winding spool 120 that enters the detection range DR of one of the at least one detectors 140.

The method may further comprising applying the marker to the winding spool, prior to detecting the unique identification code associated with the winding spool from the marker.

In one or more embodiment, a value of the weight of each unique winding spool 120, has been determined and stored in the memory 150 in association with the respective unique winding spool. In these embodiments, the method may further comprise, for each of the at least one winding spool 120: retrieving in the processing circuitry 110, the value of the measured weight of the identified winding spool 120 from the memory 150; determining, using the processing circuitry 110, a desired nip load in the reel section 100 based on the weight of the identified winding spool 120; and controlling, using the processing circuitry 110, the nip load in the reel section 100 based on the desired nip load. The nip load is thereby controlled to be adjusted to each unique winding spool 120, further improving the nip control in the reel section 100. Controlling the nip load in the reel section based on the determined optimal nip load may in this embodiment comprise generating a nip load control signal, using the processing circuitry 110, and controlling the nip load in one or more part of the reel section in response to the nip load control signal. Thereby, one or more optimal nip load, when using the identified winding spool 120 in the winding cycle, is obtained. In the embodiments where a value of the weight of each unique winding spool 120, has been determined and stored in the memory 150 in association with the respective unique winding spool the method may alternatively, or additionally, comprise, for each unique winding spool 120 that enters the weighing station 104 in the reel section 100, determining the total weight of the winding spool 120 and the paper product P wound thereon using a weighing instrument that is arranged at the weighing station 104 and communicatively connected to the processing circuitry 110. The method further comprises receiving or retrieving the total weight determined by the weighing instrument in the processing circuitry 110; receiving or retrieving, in the processing circuitry 110, the weight of the winding spool 120 from the memory 150; and determining, using the processing circuitry 110, the exact weight of the paper product P wound on the winding spool 120 by subtracting the retrieved weight of the winding spool 120 from the determined total weight. Thereby, a highly accurate determination of the weight of the paper product P wound on the winding spool 120 is obtained.

To further improve the monitoring of the performance of the winding spools 120 by removing false determinations of failure of a winding spool caused by a faulty core 701, the method may further comprise: detecting a unique core identification code, IDCORE, associated with a core mounted on the winding spool 120 from a core marker on the core, using at least one of the at least one detector 140; and identifying the core based on the unique core identification code, IDCORE, using processing circuitry 110 communicatively connected to the detector 140; wherein determining, using the processing circuitry 110, if there is a failure of the performance of the identified winding spool 120 also based on stored or measured information on the performance of the core.

### Further Embodiments

In a third aspect the invention is also realised by a paper machine comprising the monitoring system 200 according to any of the embodiment disclosed herein. It is to be noted that the present invention can be used with any kind of paper machine, including but not being limited to machines for making tissue paper.

In a fourth aspect the invention is further realized by a computer program 227 loadable into a non-volatile data carrier 225 communicatively connected to a processor 223, the computer program 227 comprising software for executing the method according any embodiment presented herein when the computer program 227 is run on the processor 223, and by a non-volatile data carrier 225 containing the computer program 227.

It is to be noted that features from the various embodiments described herein may freely be combined, unless it is explicitly stated that such a combination would be unsuitable.

1-30. (canceled)

31. A computer implemented method for monitoring the performance of at least one winding spool (120) in the reel section (100) of a paper machine, the reel section (100) being operatively connected to at least one detector (140) configured to detect a respective marker (130) on each winding spool (120), the at least one detector (140) being positioned along a winding cycle of the at least one winding spool (120), the method comprising, for each winding spool (120), the steps of:
detecting a unique identification code, ID, associated with the winding spool (120) from a marker (130) on the winding spool (120), using at least one of the at least one detector (140);
identifying the winding spool (120) based on the unique identification code, ID, using processing circuitry (110) communicatively connected to the detector (140);
determining, using the processing circuitry (110), at least one winding spool performance parameter for the identified winding spool (120) based on measurements from at least one sensor (160); and
determining, using the processing circuitry (110), if there is a failure of the performance of the identified winding spool (120) based on if the determined at least one winding spool performance parameter fulfils a requirement indicative of failure of the performance of the winding spool (120).

32. The method of claim 31, wherein identifying the winding spool (120) based on the unique identification code, ID, using the processing circuitry (110) comprises:
receiving, in the processing circuitry (110), a detection signal (S, S′, S″) from the detector (140), the detection signal (S, S′, S″) being indicative of the detected unique identification code, ID;
comparing, using the processing circuitry (110), the unique identification code, ID, to a set of unique identification codes, ID_{1 . . . n}, stored in the memory (150), wherein each unique identification code in the set is stored in association with a respective unique winding spool (120), and
if a match is found between the detected unique identification code, ID, and a unique identification code in the set stored in the database: identifying the winding spool (120) as the winding spool associated with the matching unique identification code, IDₙ, using the processing circuitry (110).

33. The method of claim 31, wherein determining at least one winding spool performance parameter for the identified winding spool (120) comprises using at least one sensor (160) configured to determine a parameter indicative of the performance of the winding spool (120).

34. The method of claim 33, wherein determining at least one winding spool performance parameter for the identified winding spool (120) further comprises retrieving, by the processing circuitry (110), at least one performance parameter from the memory (150).

35. The method of claim 31, wherein:
the requirement indicative of failure of the performance of the winding spool (120) comprises that the number of cycles performed by the winding spool (120) is equal to or exceeds a preset maximum number of cycles,
the determined at least one winding spool performance parameter comprises the number of cycles performed by the winding spool (120), and
determining, using the processing circuitry (110), that there is a failure of the performance of the identified winding spool (120) if the determined number of cycles performed by the winding spool (120) exceeds the preset maximum number of cycles.

36. The method of claim 31, wherein:
the requirement indicative of failure of the performance of the winding spool (120) comprises that the winding spool (120) is out of balance,
determining, using the processing circuitry (110), at least one winding spool performance parameter for the identified winding spool (120) based on measurements from at least one sensor (160) comprises determining at least one vibration value indicative of vibrations in a component or part of the reel section caused by the winding spool (120), based on one or more measurement from the at least one vibration sensor, and
determining, using the processing circuitry (110), that there is a failure of the performance of the identified winding spool (120) comprises comparing each of the at least one vibration value to a respective vibration threshold value indicative of a highest allowed vibration value for balanced winding spools (120).

37. The method of claim 31, wherein:
the winding spool (120) is an inflatable core shaft and the requirement indicative of failure of the performance comprises that the winding spool (120) has a valve leakage,
determining, using the processing circuitry (110), at least one winding spool performance parameter for the identified winding spool (120) based on measurements from at least one sensor (160) comprises determining a pressure in the inflatable core shaft using at least one pressure sensor, and determining, using the processing circuitry (110), that there is a failure of the performance of the identified winding spool (120) comprises comparing the determined pressure to a preset reference pressure value for the winding spool (120).

38. The method of claim 31, wherein:
the requirement indicative of failure of the performance of the winding spool (120) comprises that the ratio of unsuccessful turn-ups for the winding spool (120) is equal to or exceeds a preset maximum unsuccessful turn-up ratio,
determining, using the processing circuitry (110), at least one winding spool performance parameter for the identified winding spool (120) based on measurements from at least one sensor (160) comprises determining the number of unsuccessful turn-ups associated with the winding spool (120), and comparing it to the total amount of winding cycles performed by the winding spool (120) to determine the at unsuccessful turn-up ratio for the winding spool (120), and
determining, using the processing circuitry (110), that there is a failure of the performance of the identified winding spool (120) comprises comparing the unsuccessful turn-up ratio for the winding spool (120) to the preset maximum unsuccessful turn-up ratio.

39. The method of claim 31, further comprising, if it is determined that there is a failure of the performance of the winding spool (120), the step of generating, using the processing circuitry (110), a first control signal (C1) configured to cause an actuator (170) of the reel section (100) to remove the winding spool (120) from the reel section.

40. The method of claim 39, further comprising generating a second control signal (C2) configured to cause the same or another actuator (170, 190) of the reel section to replace the removed winding spool with a new winding spool from a winding spool storage (101).

41. The method of claim 31, further comprising applying the marker to the winding spool, prior to detecting the unique identification code associated with the winding spool from the marker.

42. The method of claim 31, wherein, for each unique winding spool (120), a value of the weight of the unique winding spool has been measured and stored in the memory (150) in association with the respective unique winding spool, wherein the method further comprises, for each of the at least one winding spool (120):
retrieving in the processing circuitry (110), the value of the measured weight of the identified winding spool (120) from the memory (150);
determining, using the processing circuitry (110), a desired nip load in the reel section (100) based on the weight of the identified winding spool (120); and
controlling, using the processing circuitry (110), the nip load in the reel section (100) based on the desired nip load.

43. The method of claim 31, wherein, for each unique winding spool (120), a value of the weight of the unique winding spool has been measured and stored in the memory (150) in association with the respective unique winding spool, wherein the method further comprises, for each of the at least one winding spool (120) that enters the weighing station (104) in the reel section (100):
determining the total weight of the winding spool (120) and the paper product (P) wound thereon using a weighing instrument that is arranged at the weighing station (104) and communicatively connected to the processing circuitry (110);
receiving or retrieving the total weight determined by the weighing instrument in the processing circuitry (110);
receiving or retrieving, in the processing circuitry (110), the weight of the winding spool (120) from the memory (150); and
determining, using the processing circuitry (110), the exact weight of the paper product (P) wound on the winding spool (120) by subtracting the retrieved weight of the winding spool (120) from the determined total weight.

44. The method of claim 31, further comprising:
detecting a unique core identification code, IDCORE, associated with a core mounted on the winding spool (120) from a core marker on the core, using at least one of the at least one detector (140);
identifying the core based on the unique core identification code, IDCORE, using processing circuitry (110) communicatively connected to the detector (140);
wherein determining, using the processing circuitry (110), if there is a failure of the performance of the identified winding spool (120) also based on stored or measured information on the performance of the core.

45. A system (200) for monitoring the performance of at least one winding spool in the reel section (100) of a paper machine, the system (200) comprising:
at least one winding spool (120), each having a respective marker (130) comprising information on a unique identification code, ID, associated with the winding spool (120);
at least one detector (140) configured to detect the respective marker (130) on each winding spool (120), wherein the at least one detector (140) is operatively connected to the reel section (100) and is positioned along a winding cycle of the at least one winding spool (120);
at least one sensor (160) configured to determine a parameter indicative of the performance of the winding spool (120);
a memory (150); and
processing circuitry (110) communicatively connected to the at least one detector (140), the at least one sensor (160) and the memory (150);
wherein:
each of the at least one detector (140) is configured to, for each of the at least one winding spool (120), detect a unique identification code, ID, associated with the winding spool (120) from the respective marker (130) on the winding spool (120);
the processing circuitry (110) is configured to, for each of the at least one winding spool (120):
identify the winding spool (120) based on the unique identification code, ID;
determine at least one winding spool performance parameter for the identified winding spool (120) based on measurements from one or more of the at least one sensor (160); and
determine if there is a failure of the performance of the identified winding spool (120) based on if the determined at least one winding spool performance parameter fulfils a requirement indicative of failure of the performance of the winding spool (120).

46. The system (200) of claim 45, wherein the processing circuitry (110) is configured to, for each of the at least one winding spool (120), identify the winding spool (120) based on the unique identification code, ID, by:
receiving a detection signal (S, S′, S″) from one of the at least one detector (140), the detection signal (S, S′, S″) being indicative of the detected unique identification code, ID;
comparing the unique identification code, ID, to a set of unique identification codes, ID_{1 . . . n}, stored in the memory (150), wherein each unique identification code in the set is stored in association with a respective unique winding spool (120), and if a match is found between the detected unique identification code, ID, and a unique identification code in the set stored in the database: identifying the winding spool (120) as the winding spool associated with the matching unique identification code, IDₙ.

47. The system (200) of claim 45, wherein the processing circuitry (110) is further configured to retrieve at least one performance parameter from the memory (150) and is configured to, for each of the at least one winding spool (120), determine at least one winding spool performance parameter for the identified winding spool (120) also based on the retrieved at least one performance parameter.

48. The system (200) of claim 45, wherein the processing circuitry (110) is configured to determine that there is a failure of the performance of the identified winding spool (120) if a determined number of cycles performed by the winding spool (120) in the reel section (100) exceeds a preset maximum number of cycles.

49. The system (200) of claim 45, wherein the at least one sensor (160) comprises at least one vibration sensor, wherein the processing circuitry (110) is configured to determine at least one vibration value indicative of vibrations in a component or part of the reel section (100) caused by the winding spool (120), based on one or more measurement from the at least one vibration sensor, and wherein the processing circuitry (110) is further configured to determine that there is a failure of the performance of the identified winding spool (120) by comparing each of the at least one vibration value to a respective vibration threshold value indicative of a highest allowed vibration value for balanced winding spools (120).

50. The system (200) of claim 45, wherein:
the winding spool (120) is an inflatable core shaft and the at least one sensor (160) comprises at least one pressure sensor configured to measure a pressure in the inflatable core shaft and to send the measured pressure value to the processing circuitry (110), and
the requirement indicative of failure of the performance comprises that the winding spool (120) has a valve leakage, and wherein the processing circuitry (110) is configured to determine that there is a failure of the performance of the identified winding spool (120) if the measured pressure value deviates more than an allowed tolerance from a reference pressure value for the inflatable core shaft.

51. The system (200) of claim 45, wherein:
the requirement indicative of failure of the performance of the winding spool (120) comprises that the ratio of unsuccessful turn-ups for the winding spool (120) is equal to or exceeds a preset maximum unsuccessful turn-up ratio,
the processing circuitry (110) is configured to determine the number of unsuccessful turn-ups associated with the winding spool (120), and comparing it to the total amount of winding cycles performed by the winding spool (120) to determine the unsuccessful turn-up ratio for the winding spool (120), and
the processing circuitry (110) is further configured to determine that there is a failure of the performance of the identified winding spool (120) if the unsuccessful turn-up ratio for the winding spool (120) is equal to or exceeds the preset maximum unsuccessful turn-up ratio.

52. The system (200) of claim 45, wherein, if it is determined that there is a failure of the performance of the winding spool (120), the processing circuitry (110) is configured to generate a first control signal (C1) configured to cause an actuator (170) of the reel section (100) to remove the winding spool (120) from the reel section.

53. The system (200) of claim 52, wherein the processing circuitry (110) is configured to generate a second control signal (C2) configured to cause the same or another actuator (170, 190) of the reel section to replace the removed winding spool with a new winding spool from a winding spool storage (101).

54. The system (200) of claim 45, wherein, for each unique winding spool (120), a value of the weight of the unique winding spool has been measured and stored in the memory (150) in association with the respective unique winding spool, wherein the processing circuitry (110) is further configured to:
retrieve the weight of the identified winding spool (120) from the memory (150);
determine a desired nip load in the reel section (100) based on the weight of the identified winding spool (120); and
control the nip load in the reel section (100) based on the desired nip load.

55. The system (200) of claim 45, wherein for each unique winding spool (120), a value of the weight of the unique winding spool has been measured and stored in the memory (150) in association with the respective unique winding spool, and the system (200) further comprises:
a weighing instrument that is arranged at the weighing station (104) and communicatively connected to the processing circuitry (110) and that is configured to determine the total weight of a winding spool (120) and a paper product (P) wound thereon when the winding spool (120) is in the weighing station (104) in the reel section (100); and
wherein the processing circuitry (110) is further configured to:
receive or retrieve the determined total weight in the processing circuitry (110) from the weighing instrument;
receive or retrieve the weight of the winding spool (120) from the memory (150); and
determine the exact weight of the paper product (P) wound on the winding spool (120) by subtracting the retrieved weight of the winding spool (120) from the determined total weight.

56. The system (200) of claim 45, wherein the system (200) is configured to perform the monitoring of the performance of the at least one winding spool (120) for each winding spool (120) that enters the detection range (DR) of one of the at least one detectors (140).

57. The system (200) of claim 45, wherein at least one of the at least one detector (140) is further configured to detect a unique core identification code, IDCORE, associated with a core mounted on the winding spool (120) from a core marker on the core, wherein the processing circuitry (110) is further configured to identify the core based on the unique core identification code, IDCORE, and to determine if there is a failure of the performance of the identified winding spool (120) also based on stored or measured information on the performance of the core.

58. A paper machine comprising the monitoring system (200) according to claim 45.

59. A computer program (227) loadable into a non-volatile data carrier (225) communicatively connected to a processor (223), the computer program (227) comprising software for executing the method according to claim 31 when the computer program (227) is run on the processor (223).

60. A non-volatile data carrier (225) containing the computer program (227) of the claim 59.
